(19) United States
(12) Patent Application Publication
(10) Pub. No.: US 2026/0331401 A1
(43) Pub. Date: Oct. 22, 2026

(54) POWER WINDOW SWITCH DEVICE

(71) Applicant: TOYOTA JIDOSHA KABUSHIKI KAISHA, Toyota-shi (JP)

(72) Inventor: Kazuhiro KAWACHI, Miyoshi-shi (JP)

(73) Assignee: TOYOTA JIDOSHA KABUSHIKI KAISHA, Toyota-shi (JP)

(21) Appl. No.: 19/546,812

(22) Filed: Feb. 23, 2026

(30) Foreign Application Priority Data
Apr. 17, 2025 (JP) 2025-068309

(51) Int. Cl. H01H 23/24; H01H 23/16

(52) U.S. Cl. CPC H01H 23/24; H01H 23/168; H01H 2231/026; H01H 2300/01

(57) ABSTRACT

A device includes a knob member having a projecting portion protruding from the mounting surface and rotatably provided around the first axis, a cam member engaged with the knob member and rotatably provided around the second axis, and having a first depressing portion and a second depressing portion, a first pusher member having an upper end abutted against the first depressing portion, a second pusher member having an upper end abutted against the second depressing portion, a first switch element abutting against the lower end of the first pusher member, and a second switch element abutting against the lower end of the second pusher member. The cam member is configured to transmit a rotational force of the knob member to the first or second pusher member, and a height from the mounting surface to the protruding end of the projecting portion is equal to or less than a predetermined value.

### CROSS-REFERENCE TO RELATED APPLICATION

This application claims priority to Japanese Patent Application No. 2025-068309 filed on Apr. 17, 2025. The disclosure of the above-identified application, including the specification, drawings, and claims, is incorporated by reference herein in its entirety.

### BACKGROUND

### 1. Technical Field

The present disclosure relates to a power window switch device.

### 2. Description of Related Art

Japanese Unexamined Patent Application Publication (Translation of PCT Application) No. 2002-538588 (JP 2002-538588 A), for example, discloses a power window switch device for a vehicle. When a switch surface portion is rotated about a rotation bar, a cam below the switch surface portion is moved together to push down a bumper. A switch is driven when the bumper is pushed down.

### SUMMARY

A typical power window switch device is configured to be operated by an operator by hooking a finger on a tip of a switch knob and pulling up the switch knob, or by pushing down the tip of the switch knob with a finger. In such a configuration, it is necessary to provide an operation hole in front of the switch knob. The operation hole needs to be sized to receive at least a finger of the operator. However, there is an issue that increasing the size of the operation hole affects the design (appearance). On the other hand, when the operation hole is made to have a minimum size to accommodate a finger, there is an issue that the operability is deteriorated for an operator having a long nail or the like.

According to the device described in JP 2002-538588 A, the installation of such an operation hole can be dispensed with. However, in the device described in JP 2002-538588 A, an operation portion is configured as a planar switch surface portion. Therefore, there is a possibility that an unintended operation of a power window may be caused when an occupant (e.g., a child such as an infant) places a hand or a knee on a door trim.

The present disclosure has been made to address the above issue, and an object of the present disclosure is to provide a power window switch device capable of effectively suppressing unintended operation by an occupant while effectively improving design.

An aspect of the present disclosure provides a power window switch device mounted on a vehicle, the power window switch device including:
a knob member including a projecting portion that projects forward and obliquely upward of a vehicle body from a predetermined mounting surface in a vehicle cabin of the vehicle, and provided so as to be rotatable about a first axis in a vehicle body width direction;
a cam member disposed below the knob member and engaged with the knob member, provided so as to be rotatable about a second axis in the vehicle body width direction, and including a first push-down portion and a second push-down portion spaced apart in a vehicle body front-rear direction;
a first pusher member provided so as to be movable in a vehicle body up-down direction, an upper end of the first pusher member being brought into abutment with the first push-down portion, causing the cam member to push down the first pusher member;
a second pusher member provided so as to be movable in the vehicle body up-down direction, an upper end of the second pusher member being brought into abutment with the second push-down portion, causing the cam member to push down the second pusher member;
a first switch element that abuts against a lower end of the first pusher member and switches from an off state to an on state when pushed down by the first pusher member; and
a second switch element that abuts against a lower end of the second pusher member and switches from an off state to an on state when pushed down by the second pusher member, in which:
when the knob member is rotated in a predetermined direction, the cam member is rotated in a direction opposite to the predetermined direction, allowing a rotational force of the knob member to be transmitted to the first pusher member or the second pusher member as a push-down force; and
a height from the mounting surface to a projecting end of the projecting portion is equal to or less than a predetermined value.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic longitudinal sectional view showing a power window switch device according to the present embodiment;

FIG. 2A is a schematic perspective view of a power window switch device according to the present embodiment as viewed from an obliquely upper side;

FIG. 2B is a schematic perspective view of a power window switch device according to the present embodiment as viewed from an obliquely upper side;

FIG. 3A is a schematic diagram illustrating an operation of a power window switch device according to the present embodiment;

FIG. 3B is a schematic diagram illustrating an operation of a power window switch device according to the present embodiment;

FIG. 3C is a schematic diagram illustrating an operation of a power window switch device according to the present embodiment;

FIG. 4 is a schematic longitudinal sectional view showing a modified power window switch device;

FIG. 5A is a schematic diagram illustrating an operation of a power window switch device according to a modification;

FIG. 5B is a schematic diagram illustrating an operation of a power window switch device according to a modification; and

FIG. 5C is a schematic diagram illustrating an operation of a power window switch device according to a modification.

### DETAILED DESCRIPTION OF EMBODIMENTS

Hereinafter, a power window switch device according to the present embodiment will be described with reference to the drawings.

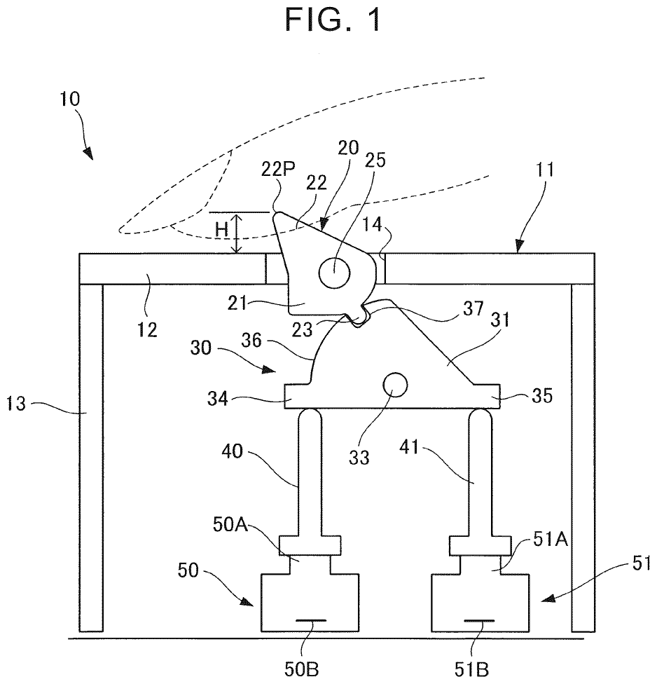

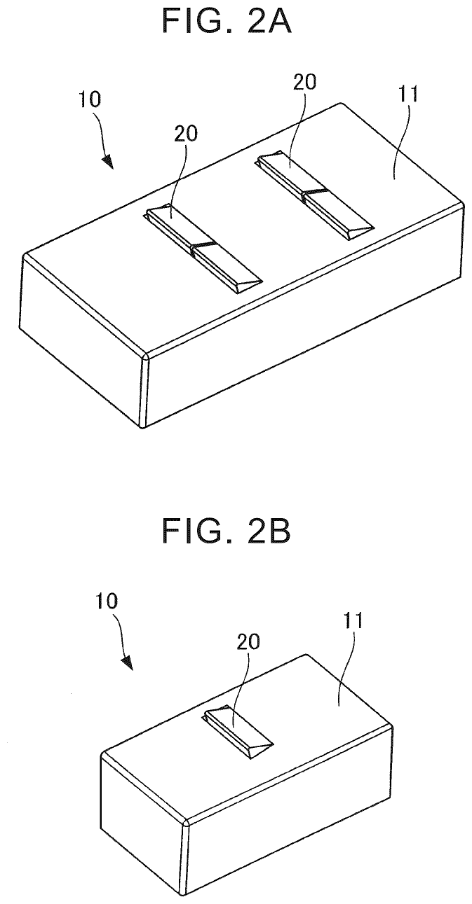

FIG. 1 is a schematic longitudinal sectional view showing a power window switch device 10 according to the present embodiment. FIGS. 2A and 2B are each a schematic perspective view of a power window switch device 10 according to the present embodiment, viewed from an obliquely upper side.

The power window switch device 10 shown in FIGS. 1 and 2A and 2B is provided, for example, on an armrest of a vehicle door, and is operated when an operator opens and closes the door window. Specifically, the power window switch device 10 includes a switch bezel 11, an operation knob 20, and a cam mechanism 30 (only shown in FIG. 1). The power window switch device 10 includes a pair of pusher rods 40 and 41 (only shown in FIG. 1) and a pair of switch elements 50 and 51 (only shown in FIG. 1).

In FIGS. 2A and 2B, there is shown a power window switch device 10 for a driver's seat with a plurality of operation knobs 20. In FIG. 2B, there is shown a power window switch device 10 for a seat other than a driver's seat having only one operation knob 20. Since these components are basically the same, the power window switch device 10 for a seat other than the driver's seat will be described below for convenience. In the following description, the vehicle body front-rear direction is referred to as the “front-rear direction”, the vehicle body width direction is referred to as the “lateral direction”, and the vehicle body vertical direction is referred to as the “vertical direction”.

The switch bezel 11 is formed of, for example, resin or the like, and includes an upper surface portion 12 and a side surface portion 13. The upper surface portion 12 of the switch bezel 11 is attached so as to be substantially flush with the upper surface of the armrest or the like. The upper surface portion 12 is an example of a mounting surface of the present disclosure. An installation hole 14 for projecting the distal end side of the operation knob 20 is formed in the upper surface portion 12 of the switch bezel 11. The installation hole 14 is opened in a substantially rectangular shape in a top view. The installation hole 14 is preferably formed with a minimal opening area that does not interfere when the operation knob 20 is operated and rotated.

The operation knob 20 (the knob member of the present disclosure) is formed of, for example, resin or the like, and includes a base portion 21, an operation projecting portion 22, and an engagement protruding portion 23. The base portion 21 is provided with a knob through-hole that penetrates in the lateral direction. A cylindrical or cylindrical knob shaft member 25 is inserted into the knob through-hole. A holding hole (not shown) for rotatably holding the knob shaft member 25 is formed on a side surface of the installation hole 14 of the switch bezel 11. The operation knob 20 is rotatably supported by the switch bezel 11 via the knob shaft member 25. The axis of the knob shaft member 25 is an example of the first axis of the present disclosure.

The operation projecting portion 22 protrudes from the base portion 21 in a substantially triangular shape when viewed in the lateral direction. The distal end portion 22P of the operation projecting portion 22 is a portion touched by the belly of the finger of the operator, and is preferably chamfered. The operation projecting portion 22 protrudes obliquely upward from the installation hole 14 in a state where the operation knob 20 is supported by the switch bezel 11. That is, the distal end portion 22P of the operation projecting portion 22 protrudes upward from the upper surface portion 12 of the switch bezel 11. The height at which the distal end portion 22P protrudes from the upper surface portion 12 (hereinafter referred to as the protruding height H) is preferably set so as to suppress a child (e.g., an infant) being caught in the power window by unintentional operation. Details of the protruding height H will be described later.

The engagement protruding portion 23 is provided at a portion of the base portion 21 opposite to the operation projecting portion 22 with the knob shaft member 25 interposed therebetween. Specifically, the engagement protruding portion 23 protrudes from the base portion 21 obliquely downward rearward. A portion of the base portion 21 on the rear side of the engagement protruding portion 23 is curved in an arc shape. The engagement protruding portion 23 engages with an engagement recess 37 of the cam mechanism 30 described later.

The cam mechanism 30 is disposed below the operation knob 20, and functions to transmit the operation force (rotation force with the knob shaft member 25 as the rotation axis) input to the operation knob 20 to the pusher rods 40 and 41 by the camming action. Specifically, the cam mechanism 30 includes a cam body 31 (a cam member of the present disclosure) swingably provided on the side surface portion 13 of the switch bezel 11. The cam body 31 is provided with a cam through hole that penetrates in the lateral direction. A cylindrical or cylindrical cam shaft member 33 is inserted into the cam through hole. A holding hole (not shown) for rotatably holding the cam shaft member 33 is formed in the side surface portion 13 of the switch bezel 11. The cam body 31 is swingably supported by the switch bezel 11 via the cam shaft member 33. The axis of the cam shaft member 33 is an example of the second axis of the present disclosure.

The cam body 31 is provided with a pair of push-down portions 34 and 35 which are spaced apart from each other in the front-rear direction and face each other with the cam shaft member 33 interposed therebetween. The upper ends of the pusher rods 40 and 41 abut on the lower surfaces of the push-down portions 34 and 35. Hereinafter, among the pair of push-down portions 34 and 35, the push-down portion 34 disposed on the front side is referred to as a “closing push-down portion”, and the push-down portion 35 disposed on the rear side is referred to as an “opening push-down portion”. Further, the pusher rod 40 abutting against the closing push-down portion 34 is also referred to as a “closing pusher rod”, and the pusher rod 41 abutting against the opening push-down portion 35 is also referred to as an “opening pusher rod”.

A cam curved portion 36 is provided above the cam shaft member 33 of the cam body 31 so as to be curved in an arc shape so as to be convex toward the front obliquely upward. The cam curved portion 36 is provided with an engagement recess 37 recessed toward the cam body 31. The engagement protruding portion 23 of the operation knob 20 is engaged with the engagement recess 37. The cam body 31 converts the rotational force transmitted from the operation knob 20 into a force that pushes down the closing pusher rod 40 and the opening pusher rod 41. In the present embodiment, the rotation radius of the cam body 31 (the length from the axial center of the cam shaft member 33 to the cam curved portion 36) is formed to be longer than the rotation radius of the operation knob 20 (the length from the axial center of the knob shaft member 25 to the distal end portion 22P). The engagement protruding portion 23 and the engagement recess 37 may be gear teeth that mesh with each other.

The closing pusher rod 40 and the opening pusher rod 41 are supported on the side surface portion 13 of the switch bezel 11 so as to be movable in the up-down direction. The lower ends of the closing pusher rod 40 and the opening pusher rod 41 abut against the switch elements 50 and 51.

The switch elements 50 and 51 are, for example, push-type tact switches, and include a button 50A, 51A and a contact 50B, 51B. The switch elements 50 and 51 are preferably short stroke type tact switches. When the button 50A, 51A of the switch elements 50 and 51 is depressed, the contact 50B, 51B is switched from the off-state to the on-state. While the button 50A, 51A is depressed, the contact 50B, 51B remains on. When the button 50A, 51A stops depressing, the button 50A, 51A returns to its pre-depressed position. When the button 50A, 51A returns to the pre-depressed state, the contact 50B, 51B of the switch elements 50, 51 are configured to switch from the on-state to the off-state.

In the following description, among the switch elements 50 and 51, the switch element 50 to which the closing pusher rod 40 abuts is also referred to as a “closing switch element”. Hereinafter, the switch element 51 with which the opening pusher rod 41 abuts is also referred to as an “opening switch element”.

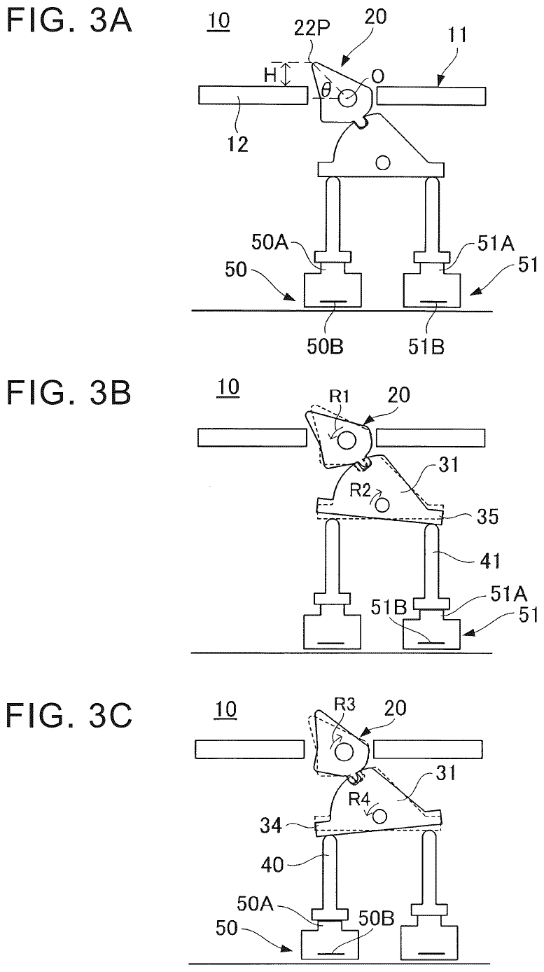

Next, the operation of the power window switch device 10 according to the present embodiment will be described with reference to FIGS. 3A to 3C.

FIG. 3A illustrates a state in which the operation knob 20 of the power window switch device 10 is not operated by the operator. Hereinafter, the state shown in FIG. 3A is referred to as a neutral state. In the neutral condition, neither the button 50A of the closing switch element 50 nor the button 51A of the opening switch element 51 is depressed. That is, the contact 50B, 51B of the switch elements 50 and 51 are both turned off.

As shown in FIG. 3B, when the operator presses down the operation knob 20 to rotate in the arrow R1 direction in the drawing from the neutral state, the cam body 31 rotates in the arrow R2 direction opposite to R1 direction. When the cam body 31 rotates in R2 direction, the opening push-down portion 35 pushes the opening pusher rod 41 downward, and the button 51A of the opening switch element 51 is pressed, whereby the contact 51B of the opening switch element 51 is switched from the off state to the on state. That is, the door window (not shown) is lowered through the window regulator to open the door window.

As shown in FIG. 3C, when the operator pulls up the operation knob 20 from the neutral position and rotates the operation knob in the arrow R3 direction in the drawing, the cam body 31 rotates in the arrow R4 direction opposite to R3 direction. When the cam body 31 rotates in R4 direction, the closing push-down portion 34 pushes the closing pusher rod 40 downward, and the button 50A of the closing switch element 50 is pressed, whereby the contact 50B of the closing switch element 50 is switched from the off state to the on state. That is, the door window is closed by raising the door window (not shown) through the window regulator.

The power window switch device 10 according to the present embodiment is configured such that the knob angle θ is about 45° in the neutral condition shown in FIG. 3A. Here, the knob angle θ is an angle formed by a line connecting the distal end portion 22P of the operation knob 20 and the rotational axis O and the upper surface portion 12 (attachment surface) of the switch bezel 11. Further, by shortening the distance from the distal end portion 22P of the operation knob 20 to the rotational axis O, the operation knob 20 can rotate with a smaller radius. That is, by setting the knob angle θ to about 45° and reducing the radius of the rotational motion of the operation knob 20, the operator can perform the opening and closing operation of the power window only by moving the finger substantially horizontally in the front-rear direction while pressing the finger toward the distal end portion 22P. This suppresses the need for the operator to pull up the operation knob 20 greatly or to push down the operation knob to a large extent, thereby making it possible to reliably improve operability. Further, since the operation hole can be dispensed with, the design (appearance) can be effectively improved.

Further, the power window switch device 10 according to the present embodiment is configured to transmit the rotational force input to the operation knob 20 to the pusher rods 40 and 41 via the cam mechanism 30. That is, by shortening the distance from the distal end portion 22P of the operation knob 20 to the rotational axis O, the rotation angle of the operation knob 20 increases. However, the rotational force of the operation knob 20 is multiplied by the cam action of the cam mechanism 30 and transmitted, so that the operation load can be reduced. Thus, when the operator operates while pressing the finger against the distal end portion 22P of the operation knob 20, it is possible to effectively suppress the operation force being sufficiently transmitted due to the slippage of the finger or the like.

In the power window switch device 10 according to the present embodiment, short stroke type tact switches are used for the switch elements 50 and 51. That is, the displacement of the pusher rods 40 and 41 to the contact 50B, 51B is suppressed to be small. This makes it possible to effectively suppress the rotation angle of the operation knob 20 becoming too large.

In addition, the power window switch device 10 according to the present embodiment is configured as follows in the neutral condition shown in FIG. 3A. The protruding height H, which is the height from the upper surface portion 12 of the switch bezel 11 to the distal end portion 22P of the operation knob 20, is configured to be equal to or less than 20 mm. Here, 20 mm means that an iron ball having a diametrical 40 mm in which a child (e.g., an infant) is assumed to be in a neutral condition is pressed against the distal end portion 22P of the operation knob 20 from all directions. In this case, it is an upper limit value for satisfying the condition that the operation knob 20 does not rotate (i.e., cannot be pulled up). As described above, by setting the protruding height H of the distal end portion 22P of the operation knob 20 to be equal to or smaller than 20 mm, it is possible to suppress a child (for example, an infant) being caught in the power window. Incidentally, the upper limit value 20 mm of the protruding height H is an example, such as the reaction force of the rotational angle and the switch elements 50 and 51 of the operation knob 20, it can be appropriately set in accordance with the specific specifications.

Although the power window switch device 10 according to the present embodiment has been described above, the present disclosure is not limited to the above-described embodiment, and various modifications can be made without departing from the object of the present disclosure.

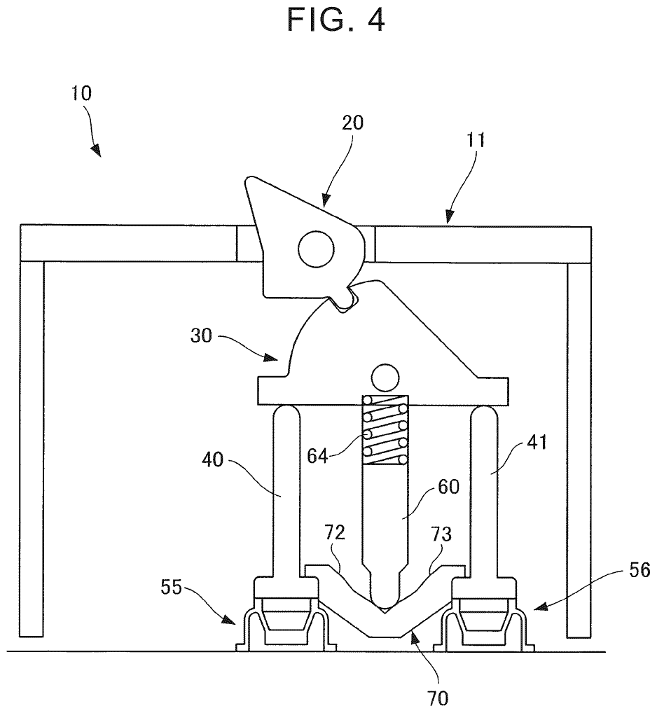

For example, in the above-described embodiment, the tact switch is used as the switch elements 50 and 51, but the switch elements 55 and 56 may be contact rubber switches as in the modified example shown in FIG. 4. In this case, it is desirable to provide the moderation peak 70 or the like in order to generate the operation feeling of the operator.

Specifically, the power window switch device 10 of the modified example includes the operation knob 20, the cam mechanism 30, and the pusher rods 40 and 41. The power window switch device 10 includes contact rubber-type switch elements 55 and 56, a click pin 60, a spring 64, and a moderation peak 70. Since the operation knob 20, the cam mechanism 30, and the pusher rods 40 and 41 are configured in the same manner as in the above-described embodiment, description thereof will be omitted.

The click pin 60 is formed in a bottomed cylindrical shape and is disposed below the cam mechanism 30. The upper end side of the click pin 60 is movably inserted into a bottomed receiving hole opening to the lower surface of the cam body 31. A spring 64 is inserted into the cylinder of the click pin 60 in a compressed state. The spring 64 brings one end into contact with the bottom of the receiving hole of the cam body 31, and brings the other end into contact with the bottom side of the click pin 60. The spring 64 biases the click pin 60 toward the moderation peak 70. The moderation peak 70 is formed in a substantially V-shape in a lateral view, and has a substantially V-shaped concave portion having a pair of inclined surface portions 72 and 73. The moderation peak 70 is disposed between the pair of pusher rods 40 and 41. The lower end of the click pin 60 comes into contact with the recessed portion of the moderation peak 70 in a press-contact state by the biasing force of the spring 64.

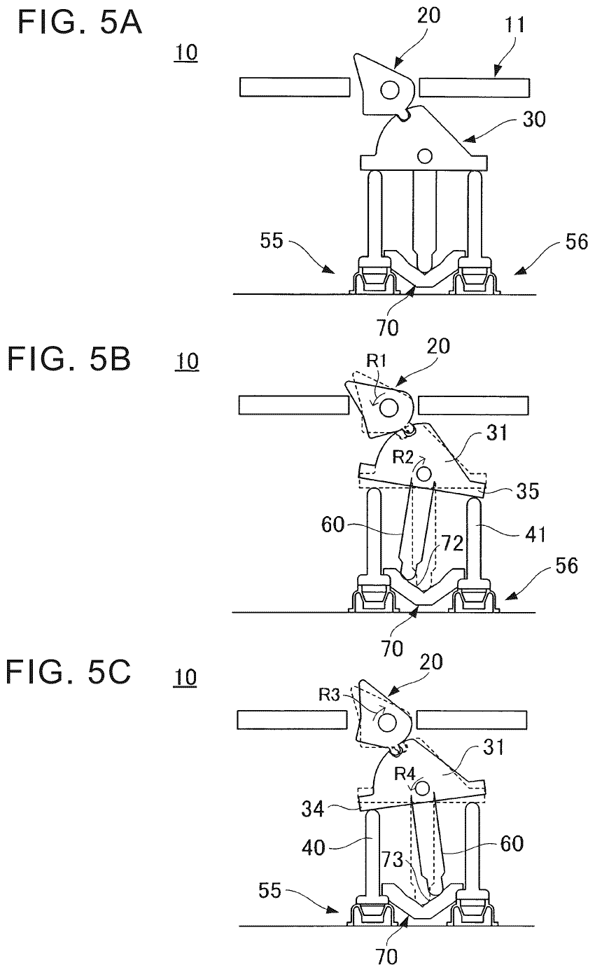

FIGS. 5A to 5C are schematic diagrams for explaining the detailed operation of the power window switch device 10 according to the modification.

FIG. 5A shows a state in which the power window switch device 10 of the modification is in the neutral state. In the neutral state, the lower end of the click pin 60 abuts the deepest portion of the recess of the moderation peak 70.

As shown in FIG. 5B, when the operator presses down the operation knob 20 to rotate in the arrow R1 direction in the drawing from the neutral state, the cam body 31 rotates in the arrow R2 direction opposite to R1 direction. When the cam body 31 rotates in R2 direction, the opening push-down portion 35 pushes down the opening pusher rod 41, and the contact rubber-type switch element 56 is pressed. At this time, the lower end of the click pin 60 abuts against the inclined surface portion 72 of the recessed portion of the moderation peak 70 on the closing pusher rod 40 side. That is, the click pin 60 is pushed toward the cam body 31 by the inclined surface portion 72, and the spring 64 (not shown) in the click pin 60 is compressed. As a result, the reaction force of the spring 64 is transmitted from the cam mechanism 30 to the operation knob 20, and an appropriate operation feeling can be generated with respect to the depression of the operation knob 20.

As shown in FIG. 5C, when the operator pulls up the operation knob 20 from the neutral position and rotates the operation knob in the arrow R3 direction in the drawing, the cam body 31 rotates in the arrow R4 direction opposite to R3 direction. When the cam body 31 rotates in R4 direction, the closing push-down portion 34 pushes down the closing pusher rod 40, and the contact rubber-type switch element 55 is pressed. At this time, the lower end of the click pin 60 abuts against the inclined surface portion 73 of the recessed portion of the moderation peak 70 on the opening pusher rod 41 side. That is, the click pin 60 is pushed toward the cam body 31 by the inclined surface portion 73, and the spring 64 (not shown) in the click pin 60 is compressed. As a result, the reaction force of the spring 64 is transmitted from the cam mechanism 30 to the operation knob 20, and an appropriate operation feeling can be generated with respect to the pulling up of the operation knob 20.

What is claimed is:

1. A power window switch device mounted on a vehicle, the power window switch device comprising:
a knob member including a projecting portion that projects forward and obliquely upward of a vehicle body from a predetermined mounting surface in a vehicle cabin of the vehicle, and provided so as to be rotatable about a first axis in a vehicle body width direction;
a cam member disposed below the knob member and engaged with the knob member, provided so as to be rotatable about a second axis in the vehicle body width direction, and including a first push-down portion and a second push-down portion spaced apart in a vehicle body front-rear direction;
a first pusher member provided so as to be movable in a vehicle body up-down direction, an upper end of the first pusher member being brought into abutment with the first push-down portion, causing the cam member to push down the first pusher member;
a second pusher member provided so as to be movable in the vehicle body up-down direction, an upper end of the second pusher member being brought into abutment with the second push-down portion, causing the cam member to push down the second pusher member;
a first switch element that abuts against a lower end of the first pusher member and switches from an off state to an on state when pushed down by the first pusher member; and
a second switch element that abuts against a lower end of the second pusher member and switches from an off state to an on state when pushed down by the second pusher member, wherein:
when the knob member is rotated in a predetermined direction, the cam member is rotated in a direction opposite to the predetermined direction, allowing a rotational force of the knob member to be transmitted to the first pusher member or the second pusher member as a push-down force; and
a height from the mounting surface to a projecting end of the projecting portion is equal to or less than a predetermined value.

2. The power window switch device according to claim 1, wherein the predetermined value is 20 mm.

3. The power window switch device according to claim 1, wherein the first switch element and the second switch element are push tact switches.

4. The power window switch device according to claim 1, wherein:
the first switch element and the second switch element are contact rubber switches; and
the power window switch device further includes a moderation peak disposed between the first pusher member and the second pusher member,
a click pin movably disposed between the cam member and the moderation peak, a lower end of the click pin being brought into abutment with the moderation peak, and
a spring that biases the click pin toward the moderation peak.
